(19) United States
(12) Patent Application Publication
(10) Pub. No.: US 2011/0189010 A1
(43) Pub. Date: Aug. 4, 2011

(54) METHOD OF MOUNTING A COMPRESSOR BLOCK ON A STATOR AND A COMPRESSOR ARRANGEMENT

(75) Inventors: Marten Nommensen, Flensburg (DE); Norbert Stöcken, Flensburg (DE); Heinz-Otto Lassen, Flensburg (DE); Thorsten Petersen, Satrup (DE)

(73) Assignee: Danfoss Compressors GmbH, Flensburg (DE)

(21) Appl. No.: 13/013,197

(22) Filed: Jan. 25, 2011

(30) Foreign Application Priority Data
Jan. 30, 2010 (DE) 10 2010 006 302.9

(51) Int. Cl. F01D 25/28; B23P 15/00

(52) U.S. Cl. 415/213.1; 29/888.02

(57) ABSTRACT

The invention concerns a method of mounting a compressor block on a front side of a stator of an electric motor that comprises a stator bore and a stator axis, a support face arrangement of the compressor block being mounted on a contact area of the stator front side and the compressor block being connected to the stator. It is endeavoured to manufacture a compressor arrangement with a high efficiency. For this purpose, before mounting the compressor block (2) on the contact area (21, 22), the stator (4) is acted upon with a clamping force corresponding to a mounting force, a spatial deviation of the contact area (21, 22) from a plane, to which the stator axis (17) is perpendicular, is determined, the support face arrangement is machined so that the deviation is compensated, and the compressor block (2) is connected to the stator (4).

### CROSS REFERENCE TO RELATED APPLICATIONS

Applicant hereby claims foreign priority benefits under U.S.C. §119 from German Patent Application No. 10 2010 006 302.9 filed on Jan. 30, 2010, the contents of which are incorporated by reference herein.

### TECHNICAL FIELD

The invention concerns a method of mounting a compressor block on a front side of a stator of an electric motor that comprises a stator bore and a stator axis, a support face arrangement of the compressor block being mounted on a contact area of the stator front side and the compressor block being connected to the stator.

Furthermore, the invention concerns a compressor arrangement with a stator that comprises a stator bore and a stator axis, and a compressor block that is fixed to a contact area of the stator front side by means of a support face, the contact area having a spatial deviation from a plane, to which the stator axis is perpendicular.

### BACKGROUND OF THE INVENTION

Such a compressor arrangement is frequently used as refrigerant compressor and used in refrigerators or other refrigeration or freezing appliances. With such refrigerant compressors, it is endeavoured to achieve the highest possible efficiency.

For this purpose, it is known from U.S. Pat. No. 6,409,481 B1 to insert the compressor block including a rotor of the electric motor fixed thereon in the stator by means of a mounting aid. In this connection, the mounting aid should ensure a uniform air gap in the circumferential direction. The compressor block is then connected to the stator and the mounting aid is removed.

U.S. Pat. No. 3,796,521 describes a method of mounting a compressor block on a stator, in which an adjustment device displaces the stator and the rotor relative to each other in relation to the stator axis until a uniform air gap has been achieved.

DE 20 01 178 C3 describes a process in which the rotor is taken from one side of the stator bore to the opposite side. The distance travelled by the rotor is measured and the rotor is moved half the distance back again. The same process is repeated in a direction that is perpendicular to the first direction. This is also made to ensure that a uniform air gap is achieved when assembling the rotor and the stator.

DE 28 17 532 B1 describes a process, in which slots are provided on the stator lamination adjacent to fixing holes, which guide the clamp bolts by means of which the compressor block is fixed on the stator. These slots shall keep a bulge of the sheets of the stator lamination away from the fixing area, on which the compressor block rests.

Up to a point, the known methods are relatively expensive. Further, it has turned out that it is practically impossible to go below certain air gap widths without jeopardising the function of the compressor. In many cases, it is even necessary to use rotors, which have a conical shape in order to prevent a contact between rotor and stator in connection with unilaterally supported rotors. This has a negative influence on the efficiency.

### SUMMARY OF THE INVENTION

The invention is based on the task of providing a compressor arrangement with a high efficiency.

With a method as mentioned in the introduction, this task is solved in that before mounting the compressor block on the contact area, the stator is acted upon with a clamping force corresponding to a mounting force, a spatial deviation of the contact area from a plane, to which the stator axis is perpendicular, is determined, the support face arrangement is machined so that the deviation is compensated, and the compressor block is connected to the stator.

With this method, the clamping of the stator, which is usually formed by a lamination stack, will anticipate the state that occurs after finishing mounting. The stator, or rather its contact area, acted upon by the tension force is then compared to an “ideal” plane, that is, the plane to which the stator axis is perpendicular. With a sheet lamination stack, it is practically unavoidable that a spatial deviation appears between this plane and the contact area. Usually, this deviation is relatively small. Under some conditions, however, it will eventually cause that the axis of a rotor that is supported on the compressor block does not correspond to the stator axis, but even has an inclination in relation thereto. If, now, before mounting the compressor block on the stator, the support face arrangement is machined so that the spatial deviation between the contact area and the plane is compensated, it can be achieved that, after mounting the compressor block on the stator, the rotor axis and the stator axis do not only have the exact same alignment, but also are congruent. This makes the air gap very uniform in the circumferential direction. As the thickness of this air gap is practically the same over the whole axial length of the stator, the thickness of the air gap can practically be reduced to a minimum. It is possible to make an air gap with a radial thickness of only 0.1 to 0.2 mm. As the deviation of the contact area in relation to the plane is usually only very small and amounts to less than one millimetre, the change of the axial position of the rotor in the stator caused by the machining of the support face arrangement is practically without influence. It has no negative effects on the efficiency of the electric motor.

Preferably, a measuring block arrangement is fixed to the contact area, and a surface arrangement of the measuring block arrangement that is facing away from the stator is used to determine the deviation. The measuring block arrangement then simulates the compressor block with regard to the tension force to be applied. The measuring block arrangement is fixed on the front side of the stator instead of the compressor block. If screw bolts are used for this purpose, these are tightened with the torque that will later also be used to fix the compressor block. This is a simple way of acting upon the stator with the tension force that also acts upon the stator when the compressor block has been mounted. At the same time, the measuring block arrangement provides a surface arrangement, by means of which the deviation of the contact face from the ideal plane mentioned above can be determined. Thus, the advantage can be utilised that the measuring block arrangement can average small local deviations, for example unevennesses, in the same way as the compressor block will. Therefore, a relatively large surface is available for the detection of the deviation, so that the measuring can be made with a relatively small effort.

Preferably, a reference bolt is inserted in the stator bore and used for fixing a measuring bridge that extends perpendicularly to the stator axis. If a reference bolt, in particular an expansion bolt is inserted in the stator bore, the circumference of the stator bore can, in a manner of speaking, be used as a reference surface for determining the position and the alignment of the stator axis. The measuring bridge is then positioned exactly perpendicularly to the axis of the reference bolt that corresponds to the stator axis. By means of the measuring bridge, the plane can be reproduced, to which the stator axis is perpendicular. Thus, by means of the measuring bridge, it is possible to determine the deviation between this plane and the contact area.

Preferably, the deviation is determined in at least two directions. In this connection, it is preferred that the two directions are perpendicular to one another. This means that the two directions define a plane, so that the deviation across the contact area can be determined in these two directions.

Preferably, the clamping force on a part of the stator, on which the compressor block is not fixed, is applied by means of bolts that remain in the stator during and after the mounting of the compressor block. This merely means that a mounting step is advanced, namely the mounting of these bolts. After finishing the measuring, the bolts serve the purpose of keeping the stator lamination together in such a manner that the individual parts of the stator cannot move in relation to one another, so that before the subsequent mounting of the compressor block on the stator, changes can no longer take place in the stator.

Preferably, the support face arrangement is ground to compensate for the spatial deviations. Here, grinding is a relatively accurate machining process that can also be performed with the required speed. As, usually, the amount of material to be removed is small, the effort that must be spent on the grinding can be held within reasonable limits.

It is preferred that the support face arrangement of the compressor block is ground in an assembly line, in which the compressor block and the stator are assembled. This is a simple way of permitting an exact allocation between a specific stator and a specific compressor block. This simplifies the manufacturing process.

Preferably, a compressor block is used, on which the support face arrangement is formed on at least two legs that have a mutual distance. This divides the support face arrangement into two or more partial areas. This involves several advantages. Firstly, these partial areas can be kept relatively small, so that a subsequent machining can be made with a reasonable effort. Secondly, a relatively small grinding tool will be sufficient. Finally, the distance provides an increased stability when assembling the compressor block and the stator. In many cases, two legs will be sufficient. However, also three or four legs can be used.

With a compressor arrangement as mentioned in the introduction, the task is solved in that the support face arrangement has a shape that compensates for a deviation between the contact area and the plane.

As explained in connection with the process, this makes it possible to connect the compressor block carrying the rotor so precisely to the stator that the stator axis and the rotor axis practically coincide. Thus, again, it is possible to make the electric motor with an extremely small air gap, which has a positive effect on the efficiency.

Preferably, the support face arrangement is ground. Thus, grinding tracks can be found on the compressor block. The grinding of the support face arrangement permits a relatively precise shaping of the support face arrangement to compensate for the deviation between the plane and the contact area.

Preferably, the compressor block has at least two legs that have a distance to one another, and the support face arrangement is formed on the side of the legs facing the stator. Thus, merely the two front sides of the legs must be ground to compensate for the deviation between the plane and the contact area. In this connection, the legs have different lengths and in some cases different front side angles.

### BRIEF DESCRIPTION OF THE DRAWINGS

In the following, the invention is described by means of a preferred embodiment in connection with the drawings, showing:

FIG. 1 is a schematic section through a compressor arrangement,

FIG. 2 is top view of a stator,

FIG. 3 is a side view of the stator,

FIG. 4 shows the stator with inserted bolt and mounted measuring bridge, and

FIG. 5 shows the stator with mounted compressor block.

### DETAILED DESCRIPTION OF THE PREFERRED EMBODIMENT

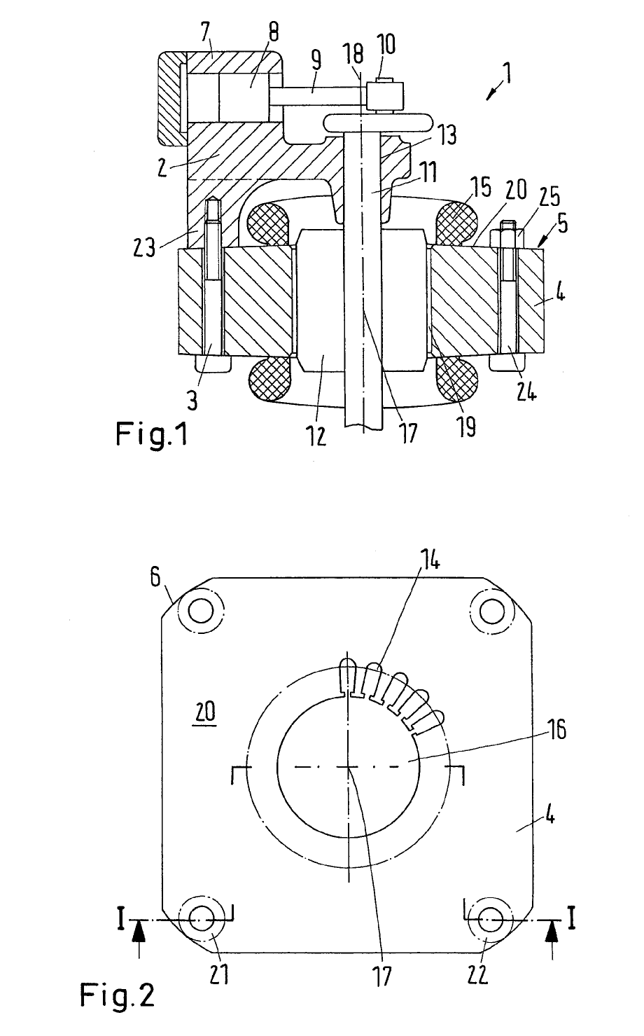

FIG. 1 shows a schematic view of a compressor arrangement 1 along a line I-I according to FIG. 2. The compressor arrangement 1 comprises a compressor block 2 that is fixed on a stator 4 of an electric motor 5 by means of two screw bolts 3. The stator 4 has the form of a sheet lamination stack with bevelled edges 6.

The compressor block 2 carries a cylinder 7, in which a piston 8 is arranged to reciprocate. The piston 8 is driven via a connecting rod 9, whose other end engages a crank pin 10. The crank pin 10 is fixed on a rotor shaft 11 that carries a rotor 12. The rotor shaft 11 is supported in a bearing 13 that is formed in the compressor block 2.

In a manner known per se, the stator 4 comprises grooves 14, in which windings are arranged. Only the winding end 15 can be seen in FIG. 1. The grooves start from a stator bore 16. A stator axis 17 is arranged in the centre of the stator bore 16. The stator axis 17 should coincide with a rotor axis 18. Between the stator 4 and the rotor 12 an air gap 19 is formed. In order to achieve the highest possible efficiency, this air gap 19 should be as thin as possible in the radial direction. In particular, it should have a thickness of less than 0.3 mm, for example 0.2 mm.

On the front side 20 facing the compressor block 2, the stator 4 comprises a contact surface that is formed by two part surfaces 21, 22. Legs 23 (only one is visible in FIG. 1) of the compressor block 2 are resting on the part surfaces 21, 22. FIG. 1 shows in an exaggerated manner that the front side 20 of the stator 4 deviates from an “ideal” plane, to which the stator axis 17 is perpendicular. In many cases, this is caused by the fact that the sheets, of which the stator 4 is formed, are not made with a constant thickness. Also a stator design, in which the individual sheets are alternatingly rotated or turned, will not with certainty lead to a front side 20 that coincides with this ideal plane, to which the stator axis 17 is perpendicular. If the compressor block 2 is mounted on this “inclined” front side 20, the direction of the rotor axis 18 usually deviates from the direction of the stator axis 17. Both axes 17, 18 do not coincide. Also when the deviation between the two axes 17, 18 is relatively small, it is no longer possible to make the air gap 19 as small as it would be desirable from an energetic point of view. The mechanical inaccuracies must be taken into consideration and provide so much space that the rotor 12 can rotate in the stator bore 16 without getting in touch with the stator 4 or at least without transferring heavy unilateral forces to the bearing.

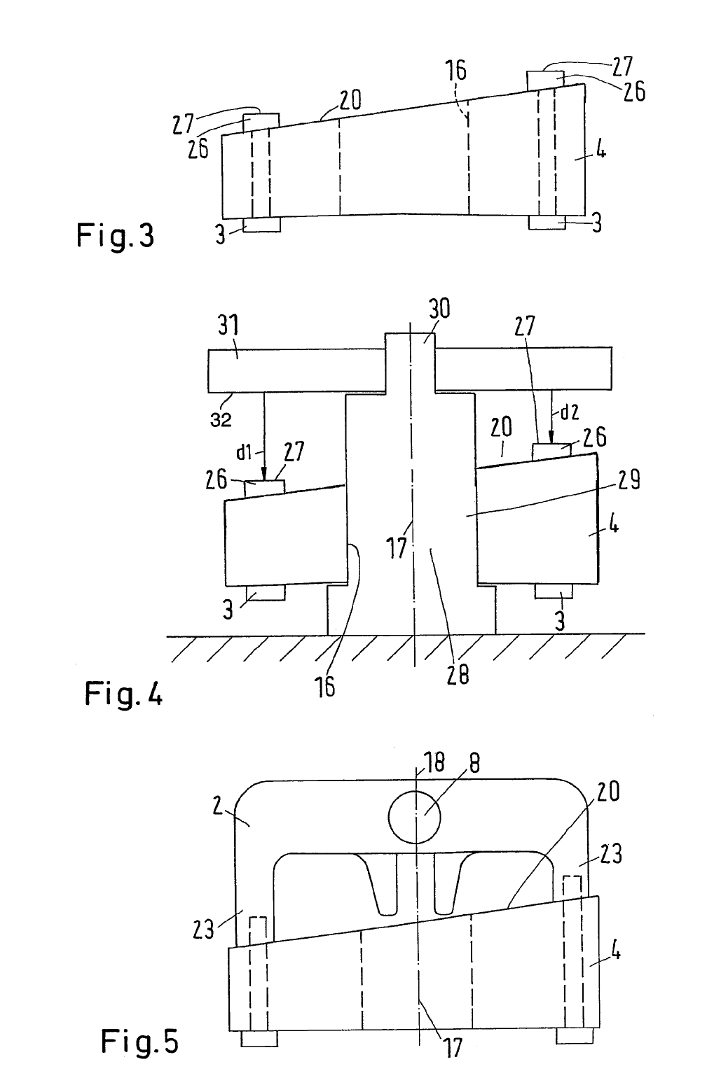

The FIGS. 3 to 5 show a method that does, in spite of the deficiencies of the stator 4, make it possible to bring the rotor axis 18 to a substantially better overlapping with the stator axis 17 than earlier. The same elements have the same reference numbers as in the FIGS. 1 and 2.

Firstly, the stator 4 is acted upon by a clamping force that corresponds to the clamping force in the assembled state and rules in the stator 4, when the compressor block has been mounted. For this purpose, not only screw bolts 3 are used, which fix the compressor block 2, but also screw bolts 24, which are located where the compressor block 2 will not rest on the stator 4. These screw bolts 24 are provided with a nut 25 by means of which the required clamping force is achieved.

In the places where the compressor block 2 shall be fixed, measuring blocks 26 are tightened to the front side 20 of the stator 4 by means of the screw bolts 3. The torque used to tighten the screw bolts 3 on the measuring blocks 26 corresponds to the torque, with which the compressor block 2 will be fixed to the stator 4. The measuring blocks 26 have a diameter or a cross-section that corresponds to the cross-section of the legs 23. On their sides facing away from the stator 4, they have a reference surface 27 that extends parallel to the front side 20, or rather, parallel to the part areas 21, 22 on the front side 20 which together form the contact surface. In this connection, the reference surfaces 27 “average” small local unevennesses.

In the stator bore 16 of the stator 4 thus assembled, a reference bolt 28 is inserted that can for example have the shape of an expansion bolt, so that the reference bolt 28 completely fills the stator bore 16 in such a manner that the axis of the reference bolt 28 corresponds to the stator axis 17. Thus, the wall of the stator bore 16 is used indirectly to determine the position of the stator axis 17.

The reference bolt 28 has a first section 29, whose outer diameter corresponds to the inner diameter of the stator bore 16, and a second section 30 with a smaller diameter. Both sections 29, 30 have coinciding axes, which again correspond to the stator axis 17.

On the second section 30 is arranged a measuring bridge 31 that extends exactly perpendicularly to the stator axis 17. By means of the measuring bridge, a distance d₁ to one measuring block 26 and a distance d₂ to a second measuring block 26 are measured. The distances d₁, d₂ can, for example, be the distance between the reference surface 27 and the bottom side 32 of the measuring bridge 31. However, it can also be a distance between the reference surface and a measuring point formed in the measuring bridge 31, or a distance from the measuring bridge 31 to a point on the front side 20.

Here, the conditions are shown in an exaggerated manner. In fact, a difference between the distances d₁, d₂ will be in the magnitude of a fraction of a millimetre.

For reasons of simplicity, it is shown that only one distance d₁, d₂ is measured per measuring block 26. In many cases, however, it may be expedient to measure several distances, so that also the inclination of the reference surface 27 can be determined.

The same measuring is made again, when the measuring bridge 31 has been rotated by 90° around the stator axis 17. Alternatively, the measuring bridge 31 may comprise additional sensors, which are able to determine distances to the measuring blocks 26 perpendicularly to the drawing plane at different positions.

Based on the data obtained in this way, the deviation of the part areas 21, 22 from a plane, to which the stator axis 17 is perpendicular, can be determined.

Before the compressor block 2 is connected to the stator 4, the compressor block 2, or rather, the front sides of the legs 23 that face the stator 4 are machined in order to compensate for the deviation. The result can be seen in FIG. 5. The legs 23 have been machined so that they hold the compressor block 2 in such a manner that the rotor axis 18 corresponds exactly to the stator axis 17.

Such a machining is expediently made by means of grinding. In a particularly simple embodiment, it is provided that the grinding of the front sides of the legs takes place in an assembly line, in which also the stator 4 and the compressor block 2 are connected to each other. In this case, it is possible, in a simple manner, to assemble the stator 4 with an exactly matching compressor block 2. An alternative foresees measuring of the stator 4 and providing it with an identification label, a compressor block 2 being machined accordingly and also provided with an identification label, so that eventually the compressor block 2 matching the stator 4 can be chosen.

Before the compressor block 2 is mounted on the stator 4, the measuring blocks 26 must be removed from the stator 4. This is, however, uncritical, as the screw bolts 24 with the nuts 25 still keep the lamination stack of the stator 4 together in such a manner that the sheets cannot change their relative position. When the screw bolts 3 are then used to fix the compressor block 2 on the stator 4, the resulting conditions will be exactly the same as earlier when fixing the measuring blocks.

The method as described will provide a highly exact alignment between the compressor block 2 and the stator 4 and thus a correspondingly exact alignment between the rotor 12 and the stator 4.

Accordingly, the size of air gap 19 arranged between the rotor 12 and the stator 4 can be reduced so much that it merely has to be adjusted to the diameter tolerances of rotor 12 and stator bore 16 without having to fear a contact between the components.

While the present invention has been illustrated and described with respect to a particular embodiment thereof, it should be appreciated by those of ordinary skill in the art that various modifications to this invention may be made without departing from the spirit and scope of the present.

What is claimed is:

1. A method of mounting a compressor block on a front side of a stator of an electric motor that comprises a stator bore and a stator axis, a support face arrangement of the compressor block being mounted on a contact area of the stator front side and the compressor block being connected to the stator, wherein before mounting the compressor block on the contact area, the stator is acted upon with a clamping force corresponding to a mounting force, a spatial deviation of the contact area from a plane, to which the stator axis is perpendicular, is determined, the support face arrangement is machined so that the deviation is compensated, and the compressor block is connected to the stator.

2. The method according to claim 1, wherein a measuring block arrangement is fixed to the contact area, and a surface arrangement of the measuring block arrangement that is facing away from the stator is used to determine the deviation.

3. The method according to claim 1, wherein a reference bolt is inserted in the stator bore and used for fixing a measuring bridge that extends perpendicularly to the stator axis.

4. The method according to claim 1, wherein the deviation is determined in at least two directions.

5. The method according to claim 1, wherein the clamping force on a part of the stator, on which the compressor block is not fixed, is applied by means of bolts that remain in the stator during and after the mounting of the compressor block.

6. The method according to claim 1, wherein the support face arrangement is ground to compensate for the spatial deviations.

7. The method according to claim 6, wherein the support face arrangement of the compressor block is ground in an assembly line, in which the compressor block and the stator are assembled.

8. The method according to claim 1, wherein a compressor block is used, on which the support face arrangement is formed on at least two legs that have a mutual distance.

9. A compressor arrangement with a stator that comprises a front side, a stator bore and a stator axis, and a compressor block that is fixed to a contact area of the stator front side by means of a support face arrangement, the contact area having a spatial deviation from a plane, to which the stator axis is perpendicular, characterised in that the support face arrangement has a shape that compensates for a deviation between the contact area and the plane.

10. The compressor arrangement according to claim 9, wherein the support face arrangement is ground.

11. The compressor arrangement according to claim 9, wherein the compressor block has at least two legs that have a distance to one another, and the support face arrangement is formed on the side of the legs facing the stator.
